(19) United States
(12) Patent Application Publication
(10) Pub. No.: US 2019/0049648 A1
(43) Pub. Date: Feb. 14, 2019

(54) LIGHTING DEVICE WITH A DIOPTER

(71) Applicant: Valeo North America, Inc., Troy, MI (US)

(72) Inventor: Valere CALAIS, Orsay (FR)

(73) Assignee: Valeo North America, Inc., Troy, MI (US)

(21) Appl. No.: 15/673,860

(22) Filed: Aug. 10, 2017

(51) Int. Cl. F21V 8/00; F21S 8/10

(52) U.S. Cl. CPC G02B 6/002; F21S 48/2243; F21S 48/1241; G02B 6/0045

(57) ABSTRACT

A light guide, a method, and an apparatus for automotive lighting are provided. The apparatus includes a light source and a light guide. The light guide includes an entry side having at least one discontinuity, an output side, and a total internal reflection side. The at least one discontinuity includes a diopter and is configured to modify angles of incidence of light rays with respect to the total internal reflection side to correct an optical path of at least a portion of the light rays, the light rays are input via a portion of the entry side and exit the light guide through the output side.

### BACKGROUND

Motor vehicles contain numerous lighting devices for both interior and exterior illumination. For example, exterior vehicle lighting devices may perform stop light functions, taillight functions, headlamp functions, daytime running light functions, dynamic bending light functions, and fog light functions.

The lighting devices may include light guides. A portion of light rays coupled to a light guide may escape the light guide which results in a decrease in efficiency. Accordingly, what is needed, as recognized by the present inventor, is a lighting device that minimizes the light lost.

The foregoing “Background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention.

### SUMMARY

An aspect of the present disclosure includes a light guide for automotive lighting, the light guide that includes an entry side having at least one discontinuity; an output side; and a total internal reflection side. The at least one discontinuity includes a diopter and is configured to modify angles of incidence of light rays with respect to the total internal reflection side to correct an optical path of at least a portion of the light rays. The light rays are input via a portion of the entry side and exit the light guide through the output side.

In one embodiment, the discontinuity includes a curved surface and a flat surface.

In one embodiment, the flat surface is angled with respect to the entry side.

In one embodiment, the flat surface is angled such as the optical path of the light rays is modified such as the angle of incidence of the light rays with respect to the total internal reflection side is greater than a critical angle for total internal reflection.

In one embodiment, the curved surface is configured to refract incident light rays such as the refracted light rays have substantially equal angle of incidence with respect to the curved surface and to the flat surface.

In one embodiment, the light guide is one entity.

An aspect of the present disclosure includes an apparatus for automotive lighting. The apparatus includes a light source and a light guide. The light guide includes an entry side having at least one discontinuity, an output side, and a total internal reflection side. The at least one discontinuity includes a diopter and is configured to modify angles of incidence of light rays with respect to the total internal reflection side to correct an optical path of at least a portion of the light rays. The light rays are input via a portion of the entry side and exit the light guide through the output side.

An aspect of the present disclosure includes a method for controlling a beam in a light guide. The method includes using at least one discontinuity to modify angles of incidence of light rays with respect to a total internal reflection side to correct an optical path of at least a portion of the light rays. The at least one discontinuity includes a diopter. The light rays are input via a portion of an entry side and exit the light guide through an output side.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic of a device for automotive lighting and/or signaling according to one embodiment;

FIG. 2 is a schematic of the device for automotive lighting and/or signaling according to another embodiment;

FIG. 3 is an exploded view of a portion of the device according to one embodiment;

FIG. 4 is an exploded view of a portion of the device according to another embodiment;

FIG. 5 is a schematic of the device that shows an optical path of a light beam according to one embodiment;

FIG. 6 is a schematic that shows the optical path of the light beam in a light guide according to one embodiment;

FIG. 7 is a schematic of the device that shows an optical path of the light beam in the device according to one embodiment;

FIG. 8 is a schematic that shows exemplary results according to one embodiment; and

FIG. 9 is a block diagram of a vehicle environment in which embodiments of the invention disclosed herein may be implemented.

### DETAILED DESCRIPTION

Referring now to the drawings, wherein like reference numerals designate identical or corresponding parts throughout several views, the following description relates to a lighting device for automotive lighting and/or signaling.

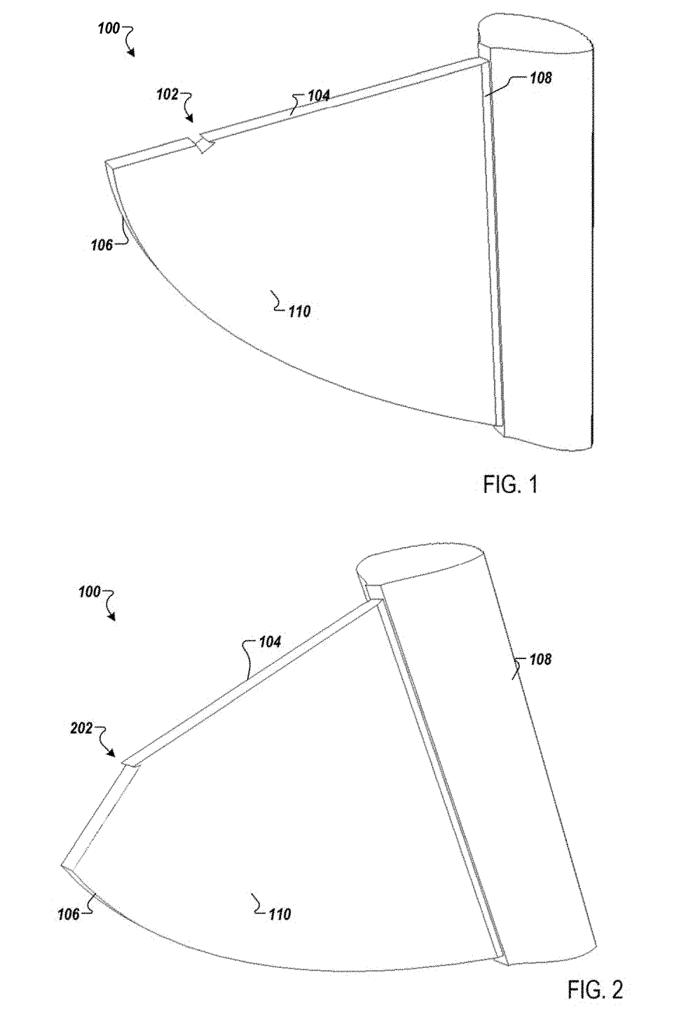

FIG. 1 is a schematic that shows a device 100 according to one embodiment. The lighting device 100 may be a light guide to guide light from an entrance surface 104 to an exit surface 108. The entrance surface 104 is substantially flat and includes one or more discontinuities 102. The exit surface 108 may be substantially flat. The device 100 may include a curved surface 106. The curved surface 106 is configured to internally reflect an incident light beam toward the exit surface 108 as further described later herein. The profile of the curved surface 106 is optimized for total internal reflection (TIR). The device 100 may be flat having two substantially parallel surfaces 110. The two parallel surfaces 110 are delimited by the entrance surface 104, the exit surface 108, and the curved surface 106.

The device 100 may be a structure formed by a glass material or a polymer material (e.g., polycarbonate, polymethyl methacrylate (PMMA)), or any other transparent material having a refractive index greater (e.g., 1.49 for PMMA) than the refractive index of the environment where the device 100 is used. In one example, the device 100 may be molded as one entity in a transparent material.

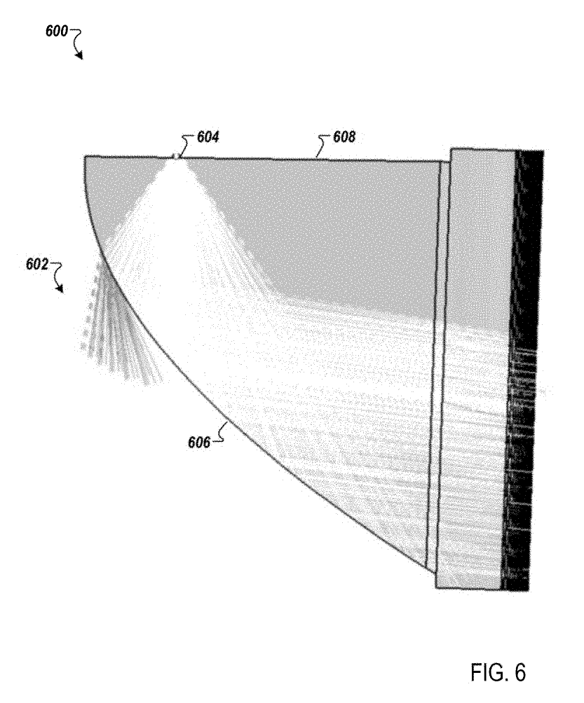

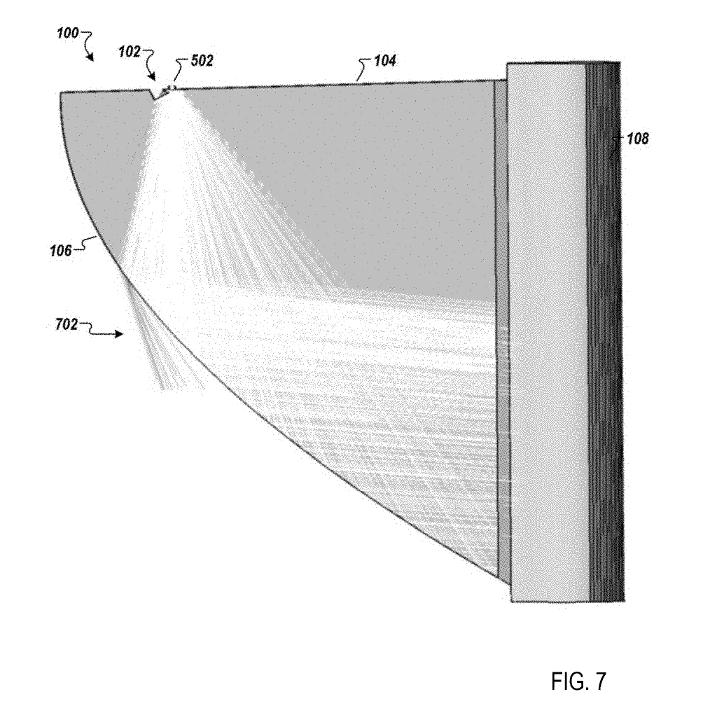

The discontinuity 102 in the entrance surface 104 creates one or more diopter surfaces (i.e., refractive surfaces between air and the material of the device 100) that modify an angle of incidence of light rays at the entrance of the device 100. The angle of incidence is modified such as the light rays may have total internal reflection (TIR) at the curved surface 106. In other words, the light rays are modified such as the angle of incidence of the rays at the curved surface 106 is greater than the critical angle such as the light rays are reflected based on TIR as shown and described in FIGS. 6 and 7. In one implementation, the one or more diopter surfaces may be created between the material of the device 100 and another material having a lower refractive index. The device 100 may be used in a fog lamp, a high beam light, a rear lamp, and the like. The exit surface 108 is adapted based on the application. For example, the exit surface 108 may be adapted to produce fog lamp beam pattern, a flat beam pattern, a high beam pattern, or a signaling pattern.

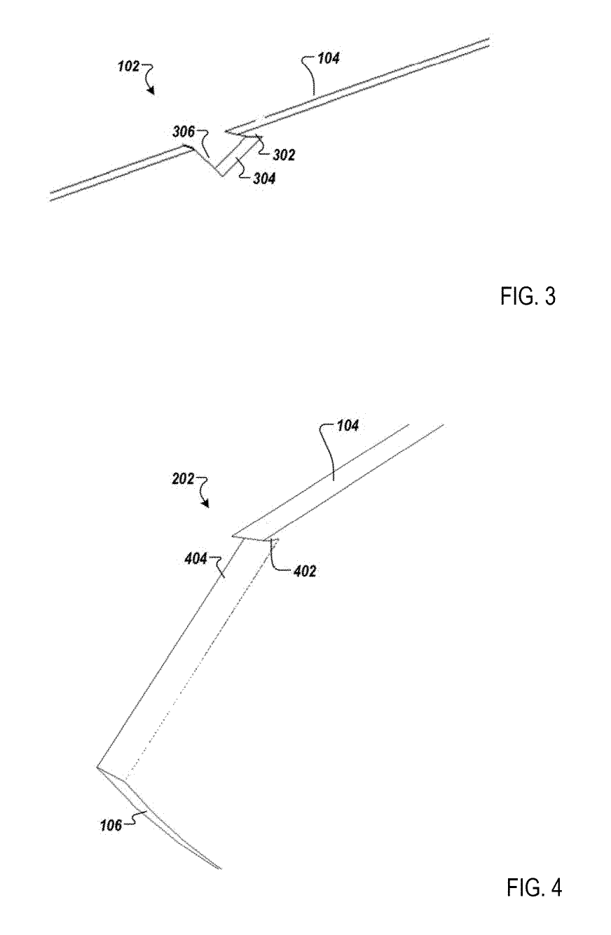

In one embodiment, the discontinuity 102 may be made by a cut inside the entrance surface 104 of the device 100. The cut is optimized to modify the direction of the incident rays to maximize TIR at the curved surface 106. An exploded view of the discontinuity 102 is shown and described in FIG. 3. The discontinuity 102 may include three surfaces: a first surface 302, a second surface 304, and a third surface 306. The surfaces 302, 304, and 306 may be flat or curved. For example, the first surface 302 may be curved such as to maintain an angle of incidence of the rays as described further below. The second surface 304 is angled with respect to the entrance surface 104. The angle between the entrance surface 104 and the second surface 304 is optimized to modify the optical path of a portion of the rays such as the rays are incident on the curved surface 106 with an angle optimized for TIR.

FIG. 2 is a schematic of the device 100 for automotive lighting and/or signaling according to another embodiment. The discontinuity 202 in the entrance surface 102 may include an angled cut. An exploded view of the discontinuity 202 is shown in FIG. 4. The discontinuity 202 may include a first curved surface 402 and a second surface 404. The first curved surface 402 is optimized to maintain the angle of the incident rays (i.e., with respect to surface 402 and 404). The second surface 404 is optimized to modify the angle of incidence of the light rays such as the angle of incidence of the rays at the curved surface 106 is greater than the critical angle for TIR.

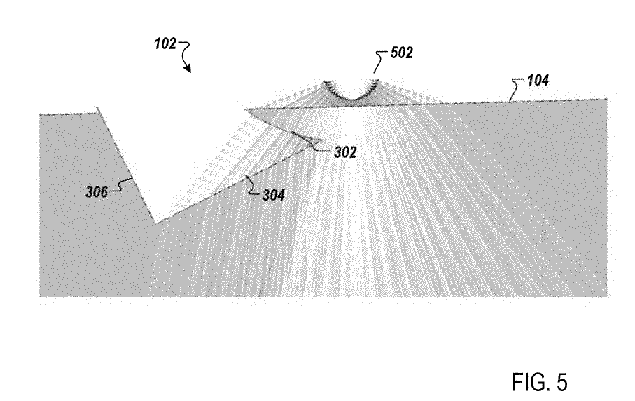

FIG. 5 is a schematic of the device 100 that shows an optical path of the light beam according to one embodiment. Light rays from a light source 502 may enter the device 100 via the entrance surface 104. The entrance surface 104 refracts the light rays. The discontinuity 102 is located proximate to the light source 502. The location of the discontinuity is optimized such as to modify a portion of the light rays that otherwise may not reflect at the curved surface 106.

A portion of the rays are refracted by the first surface 302. The first surface 302 of the discontinuity 102 is configured to maintain the direction of the rays when they exit the first surface 302. Then, the portion of rays are refracted by the second surface 304. Thus, the rays who exit the device 100 at the surface 302 reenter the device 100 via the second surface 304. The second surface 304 of the discontinuity 102 where the light beam reenters the device 100 is configured to send the rays at a right incidence angle and direction on the curved surface 106 of the device 100 to increase the flux in the beam exiting the device 100. The right incidence angle is an angle of incidence based on the refractive index of the device 100 (e.g., 1.45) and the environment (e.g., 1) that results in TIR based on Snell's law at the curved surface 106. A second portion of the rays does not pass through the discontinuity 102 and are reflected by the curved surface 106 based on TIR.

The light source 502 may include one or more light emitting devices (LEDs) or solid state light sources. The light emitted by the light source may have different shapes and colors based on the intended application. For example, the light source 502 may include an inorganic semiconductor light emitting diode or a laser diode, an organic light emitting diode (OLED), a polymer light emitting diode (PLED), a LED lamp package, a LED chip or a LED die, or an array of one or more of these devices. When a plurality of devices of LEDs is used, the LEDs may have the same or different colors.

FIG. 6 is a schematic that shows the light rays propagation in a light guide 600 according to one example. A light source 604 is coupled to an entrance surface 608 of the light guide to provide an incident beam. As described previously herein, a portion 602 of the light rays escapes the light guide 600 via surface 606 because a portion of the incident light rays at the surface 606 have an angle of incidence that is not compatible with TIR and the direction of the beam. In other words, a portion of the incident light rays refracts at surface 606 based on Snell's law.

FIG. 7 is a schematic of the device 100 that shows an optical path of the light beam according to one embodiment. As described previously herein, a portion of the beam from the light source 502 is modified by the discontinuity 102. Only a small portion 702 of the beam exits the device 100 at the curved surface 106. The beam propagates in the device 100 in planes substantially parallel to the two surfaces 110.

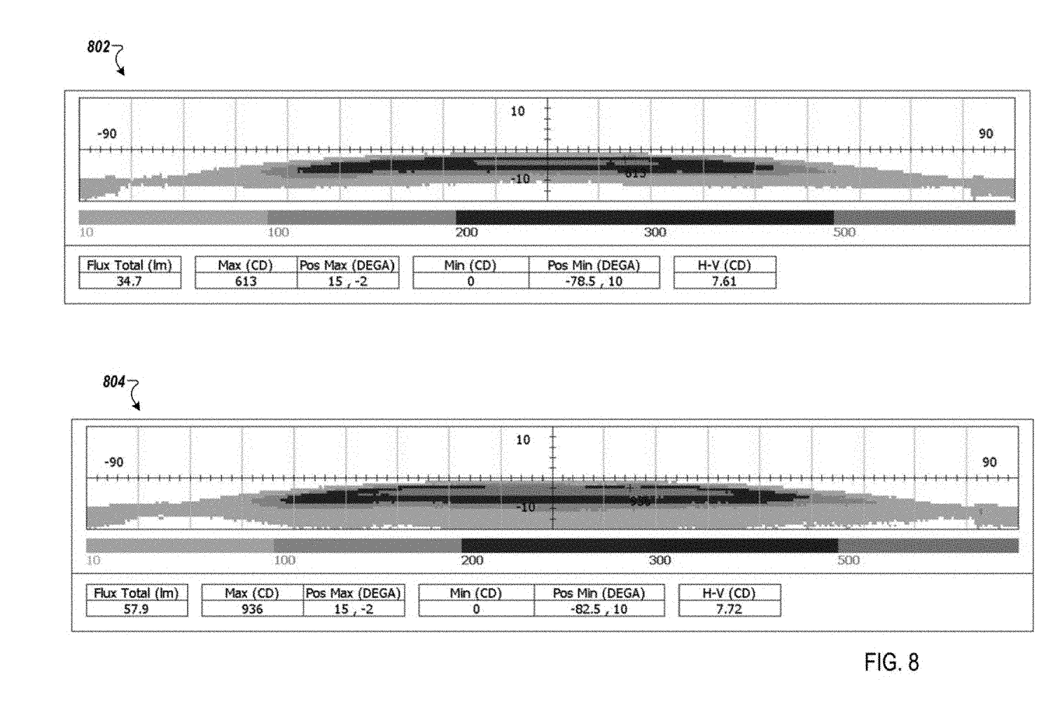

FIG. 8 is a schematic that shows exemplary results according to one embodiment. Schematic 802 shows an output flux associated with the output beam from a conventional light guide such as shown in FIG. 6. Schematic 804 shows the output flux associated with the output beam from the device 100 described herein. As shown in FIG. 8, the total flux output for the device 100 is 57.9 lm while the total output flux from a conventional light guide is 34.7 lm. Thus, the device 100 described herein provides an increase in the output flux by minimizing the light rays exiting the device 100 at the curved surface.

FIG. 9 is a simplified block diagram of a vehicle environment 900 in which embodiments of the invention disclosed herein may be implemented. The vehicle environment 900 includes a vehicle 901 in communication with one or more external devices 950 by way of one or more external networks 980. Vehicle 901 also includes various internal networks 940 for interconnecting several vehicle devices within the vehicle as will be discussed below. The vehicle environment 900 may also include one or more in-vehicle mobile device 930. External devices 950 include any device located outside the vehicle 901 such that the external device must communicate with the vehicle and its devices by an external network 980. For example, the external devices may include mobile devices, electronic devices in networked systems (e.g., servers or clients in a local area network (LAN), etc.), on board computers of other vehicles etc. In-vehicle mobile devices 930 are devices which are located within, or in the vicinity of the vehicle 901 such that the in-vehicle mobile device can communicate directly with internal networks 940 of the vehicle 901. In-vehicle mobile devices 930 may also connect with external networks 980.

Vehicle 901 includes vehicle devices integral with or otherwise associated with the vehicle 901. In the embodiment of FIG. 9, vehicle devices include one or more sensors 903, one or more actuators 905, one or more control units 907, one or more media systems 908, one or more displays 909, one or more routers 911, one or more antenna 913, and one or more on board computers 920. The one or more on board computers may generate signals having a desired duty factor to control one or more vehicle lights such as the light source 502. As used herein, the term “vehicle device” is meant to encompass sensors, actuators, controllers, electronic control units (ECUs), detectors, instruments, embedded devices, media devices including speakers, a CD and/or DVD player, a radio, vehicle navigation systems (e.g., GPS) displays, other peripheral or auxiliary devices or components associated with the vehicle 901.

Sensors 903 detect various conditions within (or in the immediate vicinity of) the vehicle 901. For example, sensors 903 may be temperature sensors, photosensors, position sensors, speed sensors, angle sensors or any other sensor for detecting a diagnostic condition or other parameter of the vehicle 901 or its ambient environment. Sensors 903 may be passive or “dumb” sensors that provide an analog representative of the sensed parameter, or so called “smart” sensors with integrated memory and digital processing capability to analyze the parameter sensed within the sensor itself. Actuators 905 cause motion of some mechanical element of the vehicle in response to a control signal. For example, actuators 905 may be hydraulic actuators, pneumatic actuators or electrical/electronic actuators such as a stepper motor. Actuators 905 may be used to move vehicle lighting devices to implement intelligent light, for example. Actuators 905 may be used to move the light source 502.

Actuators 905 may also be “dumb” devices that react to a simple analog voltage input, or “smart” devices with built-in memory and processing capability. Actuators 905 may be activated based on a sensed parameter from sensors 903, and one such sensed parameter may be a physical position of the actuator 903 itself. Thus, the sensors 903 and actuators 905 may be connected in a feedback control loop for diagnostic detection and control of the vehicle 901.

On-board computer 920 is a vehicle device for providing general purpose computing functionality within the vehicle 901. The on-board computer 520 typically handles computationally intensive functions based on software applications or “apps” loaded into memory. On-board computer 920 may also provide a common interface for different communication networks in the vehicle environment 900. On-board computer 920 includes one or more processor 921, one or more memory 923, one or more user interface 925 (e.g., the operator interface described previously herein), and one or more network interface 927.

In example embodiments, the operations for controlling the light source 502 may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar vehicle device, etc.).

Multiple internal vehicle networks represented by 940 may exist in the vehicle 901 to provide communication pathways to various vehicle devices distributed throughout the vehicle 901. An internal vehicle network 940 is a collection of nodes, such as vehicle devices, integrated with or otherwise linked to the vehicle and interconnected by communication means. Vehicle networks 940 typically include hard wired bus type networks, each providing communication pathways to particular vehicle devices distributed throughout a vehicle. FIG. 9 shows four examples of such hard wired networks: Controller Area Network (CAN) 941, Local Internet Network (LIN) 943, Flexray bus 945, and Media Oriented System Transport (MOST) network 947.

Other hard wired internal networks such as Ethernet may be used to interconnect vehicle devices in the vehicle 901. Further, internal wireless networks 949, such as near field communications, Bluetooth, etc. may interconnect vehicle devices.

Users (driver or passenger) may initiate communication in vehicle environment 900 via some network, and such communication may be initiated through any suitable device such as, in-vehicle mobile device 930, display 909, user interface 925, or external devices 950, for example to activate a mode of operation of the light source 502.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A light guide for automotive lighting, the light guide comprising:
an entry side having at least one discontinuity;
an output side;
a total internal reflection side; and
wherein the at least one discontinuity includes a diopter and is configured to modify angles of incidence of light rays with respect to the total internal reflection side to correct an optical path of at least a portion of the light rays, the light rays being input via a portion of the entry side and exit the light guide through the output side.

2. The light guide of claim 1, wherein the discontinuity includes a curved surface and a flat surface.

3. The light guide of claim 2, wherein the flat surface is angled with respect to the entry side.

4. The light guide of claim 3, wherein the flat surface is angled such as the optical path of the at least a portion of the light rays is modified such as the angle of incidence of the light rays with respect to the total internal reflection side is greater than a critical angle for total internal reflection.

5. The light guide of claim 2, wherein the curved surface is configured to refract incident light rays such as the refracted light rays have substantially equal angle of incidence with respect to the curved surface and to the flat surface.

6. The light guide of claim 1, wherein the light guide is one entity.

7. An apparatus for automotive lighting, the apparatus comprising:
a light source; and
a light guide including
an entry side having at least one discontinuity;
an output side;
a total internal reflection side; and
wherein the at least one discontinuity includes a diopter and is configured to modify angles of incidence of light rays with respect to the total internal reflection side to correct an optical path of at least a portion of the light rays from the light source, the light rays are input via a portion of the entry side and exit the light guide through the output side.

8. The apparatus of claim 7, wherein the light source is a light emitting diode.

9. The apparatus of claim 7, wherein the at least one discontinuity is located proximate to the light source.

10. The apparatus of claim 7, wherein the discontinuity includes a curved surface and a flat surface.

11. The apparatus of claim 10, wherein the flat surface is angled with respect to the entry side.

12. The apparatus of claim 11, wherein the flat surface is angled such as the optical path of the at least the portion of light rays is modified such as the angle of incidence of the light rays with respect to the total internal reflection side is greater than a critical angle for total internal reflection.

13. The apparatus of claim 10, wherein the curved surface is configured to refract incident light rays such as the refracted light rays have substantially equal angle of incidence with respect to the curved surface and to the flat surface.

14. The apparatus of claim 7, wherein the light guide is one entity.

15. The apparatus of claim 7, wherein the light guide is a flat light guide.

16. A method for controlling a beam in a light guide, the method comprising:
using at least one discontinuity to modify angles of incidence of light rays with respect to a total internal reflection side to correct an optical path of at least a portion of the light rays from a light source; and wherein the at least one discontinuity includes a diopter, the light rays being input via a portion of an entry side and exit the light guide through an output side.

17. The method of claim 16, wherein the at least one discontinuity is located proximate to the light source.

18. The method of claim 16, wherein the discontinuity includes a curved surface and a flat surface.

19. The method of claim 18, wherein the flat surface is angled with respect to the entry side.

20. The method of claim 17, wherein the flat surface is angled such as the optical path of the at least a portion of the light rays is modified such as the angle of incidence of the light rays with respect to the total internal reflection side is greater than a critical angle for total internal reflection.
